(19) United States
(12) Patent Application Publication
(10) Pub. No.: US 2025/0165015 A1
(43) Pub. Date: May 22, 2025

(54) GENERATING MECHANICAL FORCE IN ACCORADANCE WITH SENSOR DATA BY ELECTROMAGNETICALLY ACTUATING A COMPLIANT MECHANISM

(71) Applicant: Arizona Board of Regents on behalf of the University of Arizona, Tucson, AZ (US)

(72) Inventor: Kavan Hazeli, Tucson, AZ (US)

(21) Appl. No.: 18/511,736

(22) Filed: Nov. 16, 2023

(51) Int. Cl. G05D 15/01; G06F 3/01

(52) U.S. Cl. CPC G05D 15/01; G06F 3/016

(57) ABSTRACT

A device for generating forces or motions in accordance with sensor data. The device includes one or more compliant mechanism units and an electromagnetic actuator configured to actuate each compliant mechanism unit. By actuating a compliant mechanism unit using an electromagnetic actuator, the device can generate a force or motion in accordance with received sensor data using hardware components that are much smaller than the servo motors used in existing systems. In various embodiments, the device may actuate one or more compliant mechanism units to control the shape of a haptic meta-surface, activate and deactivate microswitches, open and close microfluidic channels, etc. In various embodiments, the device may actuate one or more compliant mechanism units in accordance with pixel values extracted from light detection and ranging (LiDAR) data, two-dimensional image data, or other sensor data.

### CROSS-REFERENCE TO RELATED APPLICATIONS

This application claims priority to U.S. Prov. Pat. Appl. No. 63/383,997, filed Nov. 16, 2023, which is hereby incorporated by reference.

### FEDERAL FUNDING

None

### BACKGROUND

In many electronic devices, it may be desirable to generate mechanical force or motion in accordance with sensor data indicative of the environment surrounding the device. U.S. patent application Ser. No. 18/236,842, for instance, describes generating haptic feedback for visually impaired users in accordance with a three-dimensional representation of the environment captured using light detection and ranging (LiDAR). In other examples, it may be desirable to generate mechanical movement (e.g., robotic or other motion) or force (e.g., activation of mechanical switches, opening or closing of fluidic channels, etc.) in accordance with sensor data (e.g., LiDAR data, two-dimensional still or video image data, etc.) captured by the device. For instance, it may be desirable to precise control medical equipment (e.g., infusion pumps, patient monitoring systems, diagnostic machines, etc.) in response to real-time imaging and/or monitoring of a patient's condition.

In general, electronic devices generate mechanical force or motion using servo motors, which produce torque and velocity in accordance with a current and voltage supplied by servo controllers. (The servo controllers are often to receive feedback indicative of the state of the servo motor, such as the current supplied to or velocity or position of the servo motor, to adjust the supply current or voltage such that the force or motion generated by the servo motor is consistent with the commanded parameters.) Servo motors and the controllers and feedback devices used to control them, however, are larger than would be practical to incorporate into many electronic devices. Additionally, servo motors consume more energy and generate more torque and velocity than is necessary for those electronic devices.

Accordingly, there is a need for an improved system for generating mechanical force or motion in accordance with sensor data.

### SUMMARY

Disclosed is a device for generating forces or motions in accordance with sensor data. The device includes one or more compliant mechanism units and an electromagnetic actuator configured to actuate each compliant mechanism unit. By actuating a compliant mechanism unit using an electromagnetic actuator, the device can generate a force or motion in accordance with received sensor data using hardware components that are much smaller than the servo motors used in existing systems. In various embodiments, the device may actuate one or more compliant mechanism units to control the shape of a haptic meta-surface, activate and deactivate microswitches, open and close microfluidic channels, etc. In various embodiments, the device may actuate one or more compliant mechanism units in accordance with pixel values extracted from light detection and ranging (LiDAR) data, two-dimensional image data, or other sensor data.

### BRIEF DESCRIPTION OF THE DRAWINGS

Aspects of exemplary embodiments may be better understood with reference to the accompanying drawings. The components in the drawings are not necessarily to scale, emphasis instead being placed upon illustrating the principles of exemplary embodiments.

FIG. 1 is a block diagram of a disclosed system according to exemplary embodiments.

FIGS. 2A-2C are diagrams illustrating a compliant mechanism having electromagnetic actuators according to an exemplary embodiment.

FIGS. 3A and 3B are diagrams illustrating a compliant mechanism unit 281 according to another exemplary embodiment.

FIGS. 4A-4D are diagrams of a compliant mechanism unit having a height that is dependent on a magnetic field provided by the electromagnetic actuator according to an exemplary embodiment.

FIG. 5 is a graph illustrating the relationship between the magnetic field generated by the electromagnetic actuator and vertical displacement of the compliant mechanism unit of FIGS. 4A-4D according to an exemplary embodiment.

FIG. 6 is a diagram illustrating an array of individually controllable compliant mechanism units according to an exemplary embodiment.

FIGS. 7A and 7B illustrate a process for controlling compliant mechanism units in accordance with pixel map values from a LiDAR system according to exemplary embodiments.

### DETAILED DESCRIPTION

Reference to the drawings illustrating various views of exemplary embodiments is now made. In the drawings and the description of the drawings herein, certain terminology is used for convenience only and is not to be taken as limiting the embodiments of the present invention. Furthermore, in the drawings and the description below, like numerals indicate like elements throughout.

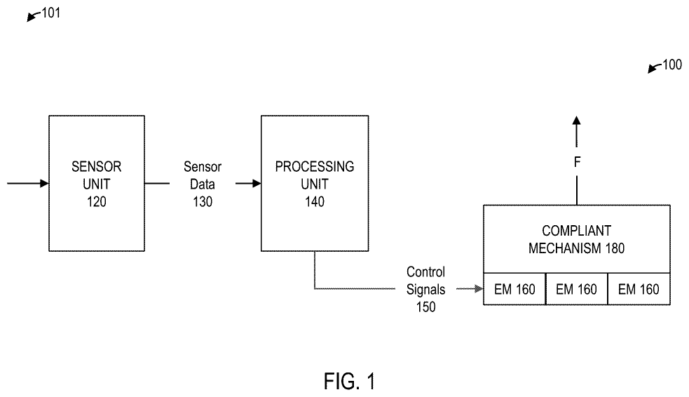

FIG. 1 is a block diagram of a disclosed system 100 in an example environment 101 according to exemplary embodiments. As shown in FIG. 1, the system 100 includes a sensor unit 120, a processing unit 140, and one or more compliant mechanisms 180 with electromagnetic actuators 160.

The sensor unit 120 may include any hardware device capable of capturing sensor data 130 indicative of the environment 101. For example, the sensor unit 120 may include a camera that captures two-dimensional (still or video) images of the environment 101 or a light detection and ranging (LiDAR) scanner that captures three-dimensional sensor data 130 indicative of the distance and angle of objects and surfaces in the environment 101 (relative to the location and orientation of the system 100) by targeting those objects and surfaces with light (e.g., ultraviolet light, visible light, near infrared light, micropulse or high energy lasers, etc.) and measuring the time for the reflected light to return to the LiDAR scanner. In those or other embodiments, the sensor unit 120 may capture sensor data 130 indicative of those distances and/or angles using ultrasonic proximity detectors, a radiolocation system (e.g., radar) that emits electromagnetic waves and captures reflected electromagnetic waves, a sonic navigation and ranging (sonar) sensor that emits pulses of sound and captures echoed sound, etc.

In mechanical engineering, a compliant mechanism 180 is a flexible device that achieves force and motion transmission through elastic body deformation. Compliant mechanisms may be monolithic or jointless structures with components that are moveable as governed by the relative flexibility of those or other components (rather than by rigid-body joints).

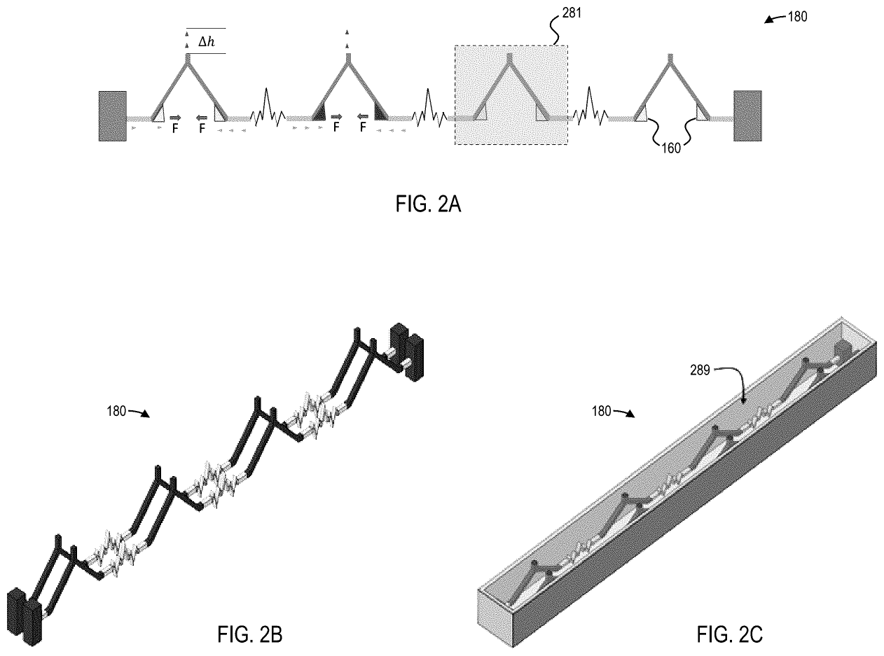

In prior art devices (e.g., backpack latches, paper clips, a bow-and-arrow, etc.), movement of compliant mechanism components and/or forces applied by compliant mechanisms are induced by applying a mechanical force. By contrast, as described in more detail below with reference to FIGS. 2-6, the compliant mechanism(s) 180 in the disclosed system 100 include electromagnetic actuators 160 that enable disclosed system 100 to generate mechanical motion or force in accordance with the received sensor data 130.

The processing unit 140 may include any hardware component configured to generate control signals 150 based on the sensor data 130 received from the sensor unit 120 and output those control signals 150 to the electromagnetic actuators 160 to control the compliant mechanism(s) 180. For example, the processing unit 140 may include memory that stores the received sensor data 130 and software instructions for generating control signals 150 in accordance with received sensor data 130 and hardware processing device that executes those stored software instructions to generate the control signals 150 in accordance with received sensor data 130. The hardware processing unit may be, for example, a microprocessor, a microcontroller, an application-specific integrated circuit (ASIC), a field-programmable gate array (FPGA), etc. Alternatively, the processing unit 140 may include a digital circuit (e.g., a finite state machine) with hardware registers that store the received sensor data 130 (and, in some embodiments, the current state of the compliant mechanism(s) 180) and hardware combinational logic blocks configured to generate the control signals 150 in accordance with received sensor data 13.

FIGS. 2A-2C are diagrams illustrating a compliant mechanism 180 having electromagnetic actuators 160 according to an exemplary embodiment.

As shown in FIG. 2A, the compliant mechanism 180 includes an array of compliant mechanism units 281 each having an electromagnetic actuator 160. In the embodiment of FIG. 2A, each electromagnetic actuator includes two electromagnets at the base of the compliant mechanism units 281. When supplied with a voltage, the electromagnetic actuator 281 causes the base of that compliant mechanism unit 281 to compress and the height of that compliant mechanism unit 281 to increase by a height change Δh. In some embodiments, the electromagnetic actuators 160 may be active electromagnetic actuators wherein the height of each compliant mechanism unit 281 is increased by connecting that electromagnetic actuator 160 to the voltage source. In other embodiments, the electromagnetic actuators 160 may be passive electromagnetic actuators wherein the height of each compliant mechanism unit 281 is decreased by connecting the electromagnetic actuator 160 to the voltage source.

As shown in the FIG. 2B, the compliant mechanism 180 may include a two-dimensional array of compliant mechanism units 281. As shown in FIG. 2C, the compliant mechanism 180 may include a flexible membrane 289 covering the compliant mechanism units 281, which assumes its form and shape by the relative heights of the underlying compliant mechanism units 281.

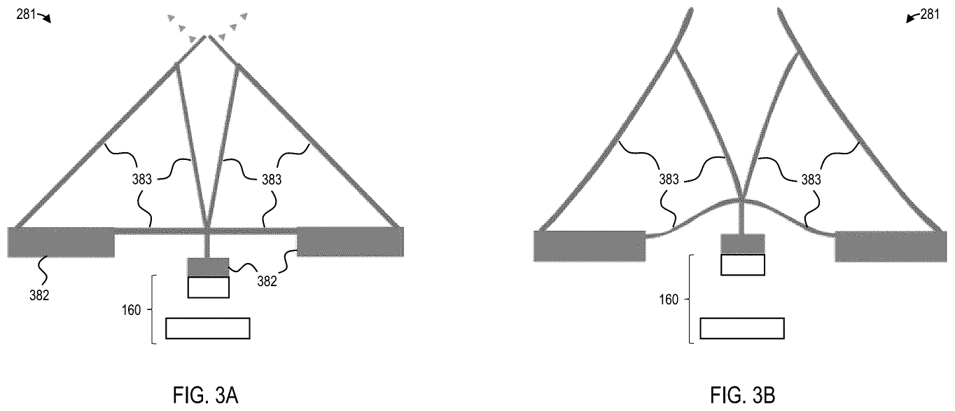

FIGS. 3A and 3B are diagrams illustrating a compliant mechanism unit 281 according to another exemplary embodiment.

A significant aspect of the disclosed system 100 is that the compliant mechanism units 281 can be used to deliver a wide range of motion, including intuitive motion (for example, as shown in FIGS. 2A-2C) and/or counter-intuitive motion (for example, as shown in FIG. 3B) depending on the design of the compliant mechanism units 281. Counter-intuitive motions cannot be readily delivered with servomotors.

As shown in FIGS. 3A-3B, a compliant mechanism unit 281 may include structural components 382 and flexible components 383. The structural components 382 may be, for example, acrylonitrile butadiene styrene (ABS) having a Young's modulus between 1.9 and 2.5 gigapascals (GPa). The flexible components 383, for example, may be thermoplastic polyurethane (TPU) 95A having a tensile modulus of about 2 millipascals (MPa). Again, the compliant mechanism unit 281 includes an electromagnetic actuator 160 that, based on an applied voltage, transitions the compliant mechanism unit 281 to and from an unextended state (as shown in FIG. 3A) and an extended state (as shown in FIG. 3B).

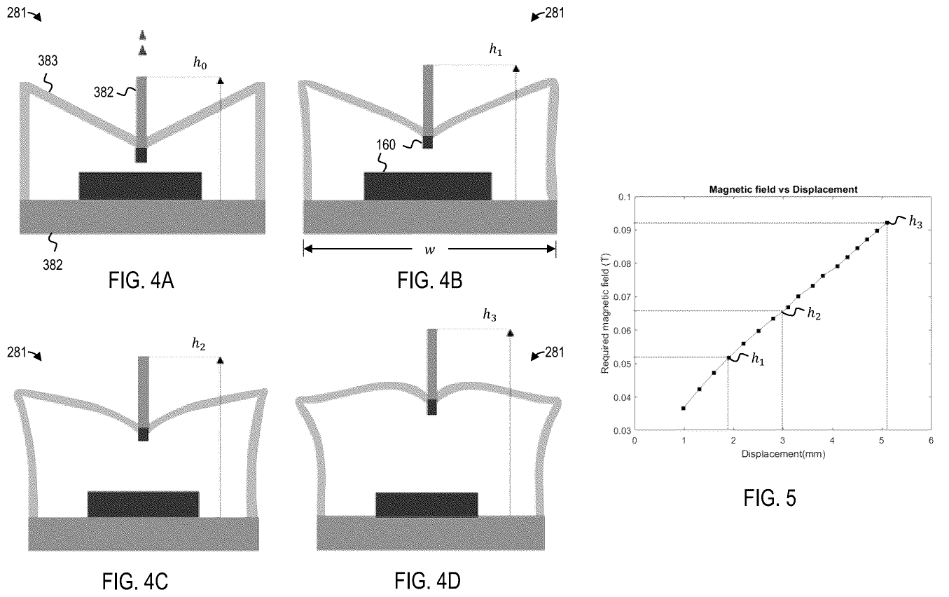

FIGS. 4A-4D are diagrams of a compliant mechanism unit 281 having a height that is dependent on a magnetic field provided by the electromagnetic actuator 160 according to an exemplary embodiment.

As shown in FIGS. 4A-4D, the compliant mechanism unit 281 may include structural components 382 and flexible components 383 and an electromagnetic actuator 160. The compliant mechanism unit 281 may have a width w of 2 centimeters (cm) and an unextended height h₀ (e.g., 1 cm) as shown in FIG. 4A. Based on the voltage applied to the electromagnetic actuator 160, the height of the 281 may transition between the unextended height h₀, a height h₁, (e.g., 1.2 cm) as shown in FIG. 4B, a height h₂ (e.g., 1.3 cm) as shown in FIG. 4C, a height h₃, (e.g., 1.5 cm) as shown in FIG. 4C, etc.

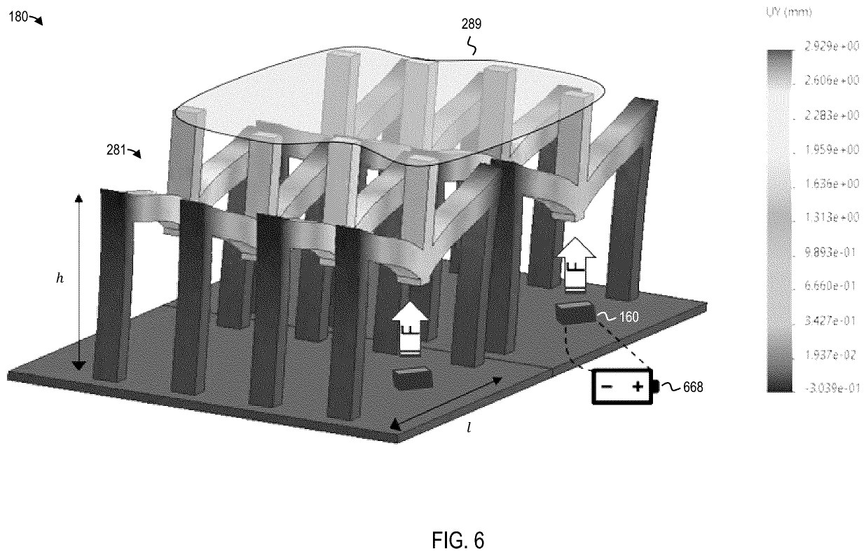

FIG. 5 is a graph illustrating the relationship between the magnetic field generated by the electromagnetic actuator 150 and vertical displacement of the compliant mechanism unit 281 of FIGS. 4A-4D according to an exemplary embodiment.

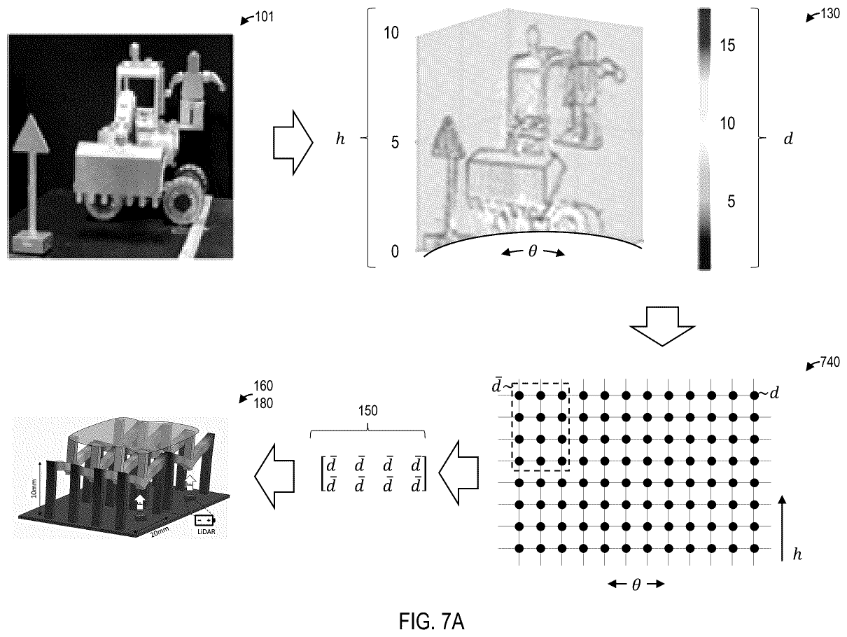

FIG. 6 is a diagram illustrating an array of individually controllable compliant mechanism units 281 according to an exemplary embodiment.

As shown in FIG. 6, the compliant mechanism 180 includes a flexible membrane 289 attached to array of compliant mechanism units 281. The compliant mechanism units 281 are individually controllable (by electromagnetic actuators 160 electrically connected to a voltage source 668) in accordance with the received sensor data 130 (e.g., LiDAR pixel map values or grayscale pixel values from a digital image) as described below. Accordingly, in the embodiment of FIG. 6, the flexible membrane 289 forms a haptic meta-surface having an array of heights that each adjust in accordance with the relative position of one of the compliant mechanism units 281, which adjust in accordance with the received sensor data 130 (e.g., LiDAR pixel map values or grayscale pixel values).

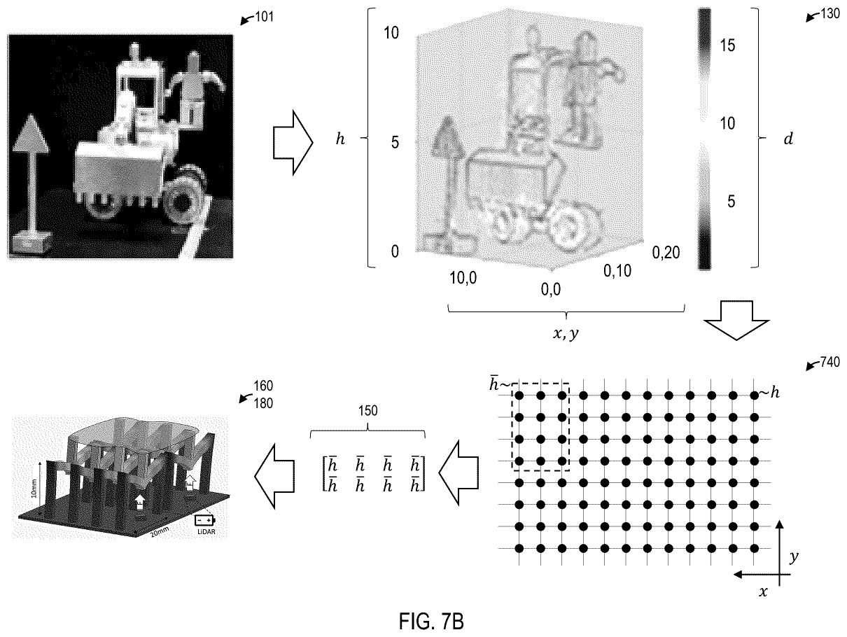

FIGS. 7A and 7B illustrate a process for controlling compliant mechanism units 281 in accordance with pixel map values from a LiDAR system according to exemplary embodiments. A similar process may be used for controlling compliant mechanism units 281 in accordance with other sensor data 130, such as grayscale pixel values from two-dimensional image data.

As shown in FIG. 7A, sensor data 130 indicative of the environment 101 (e.g., LiDAR data output by a LiDAR scanner) can be used to create a three-dimensional representation of the environment, for example a LiDAR pixel map 740a that includes the depth d of each object at each of a number of heights h and each of a number of angles θ (e.g., relative to the orientation of the LiDAR scanner). For instance, a Digital Analog LiDAR system may be used to generate a LiDAR pixel map that includes a 640×480 array of height values h at each combination of 640 lateral positions x and 480 longitudinal positions y. Alternatively, as shown in FIG. 7B, those depths d at each angle θ can be converted (using simple geometry) to lateral positions x and longitudinal positions y relative to a predetermined origin 0,0 (e.g., the location of the LiDAR scanner) to form a LiDAR pixel map that includes the height h of each object at each of a number of positions x, y.

The processing unit 140 described above with reference to FIG. 1 generates control signals 150 in accordance with the received sensor data 130. For example, the processing unit 140 may reduce the array of pixel values in the LiDAR pixel map 740 (e.g., the depth values d in the embodiment of FIG. 7A or the height values h in the embodiment of FIG. 7B) to an array having the same size as the compliant mechanism 180, for example by dividing the LiDAR pixel map into regions and averaging the pixel values in each region. In the embodiments of FIGS. 7A and 7B, for instance, the compliant mechanism 180 includes a 4×2 array of compliant mechanism units 281. Accordingly, the processing unit 140 may divide the pixel map 740 into eight regions forming a 4×2 array, with each of the eight regions in the LiDAR pixel map 740 having a location relative to the other regions of the LiDAR pixel map 740 that corresponds to the location of one of the eight compliant mechanism units 281 (relative to the locations of the other compliant mechanism units 281). The average pixel value (e.g., the average height value h̅ in the embodiment of FIG. 7A, the average depth value d̅ in the embodiment of FIG. 7B) is calculated for each region in the array. The processing unit 140 may then output control signals 150 to control each compliant mechanism unit 281 in accordance with the average pixel value calculated for the region of the LiDAR pixel map that corresponds to that compliant mechanism unit 281. For example, the average pixel values may be converted into state values (e.g., based on the magnitude of each average pixel value, the relationship between the absolute magnitude of each average pixel value and a series of predefined thresholds, the magnitude of each average pixel value relative to the other average pixel values, the relationship between the relative magnitude of each average pixel value and a series of predefined thresholds, etc.). To transmit those state values to the compliant mechanism 180, the state values may be concatenated into a string (e.g., by a universal asynchronous receiver-transmitter), which may be transmitted wirelessly (e.g., via Bluetooth) as needed (i.e., in response to any change in the array) to a microcontroller that converts the string back into the separate state values.

The electromagnetic actuators 160 apply an electromagnetic field to each compliant mechanism unit 281 in accordance with the control signal 150 generated in accordance with the average pixel value calculated for the region of the LiDAR pixel map 740 corresponding to that compliant mechanism unit 281. For instance, as shown in FIGS. 4 and 5, the required electromagnetic field may be applied such that the height of each compliant mechanism unit 281 (relative to the unextended height h₀ of the compliant mechanism unit 281) is proportional to the absolute or relative magnitude of the average pixel value calculated for the region of the LiDAR pixel map 740 corresponding to that compliant mechanism unit 281. By controlling the compliant mechanism units 281 in accordance with the sensor data 130, the disclosed system 100 adjusts the shape of the 289 to conform to the shape and size of the objects in the surrounding environment 101, either from the point-of-view of the LiDAR scanner (e.g., in the embodiment of FIG. 7A) or as seen from above (e.g., in the embodiment of FIG. 7B).

By combining the compliant mechanism 180 with electromagnetic actuators 160, the disclosed system 100 generates forces or motions in accordance with received sensor data 130 using hardware devices that are much smaller than servo motors. In the embodiment of FIG. 6, for example, each compliant mechanism unit 281 may have a length 1 of about 20 mm and an unextended height h of about 10 mm.

Depending on the application and design requirements, the disclosed system 100 and the individual compliant mechanism units 281 may be realized in different sizes and geometries. In various embodiments, the size of each compliant mechanism unit 281 can vary, for example from micro size units to centimeter size units. Additionally, any number of compliant mechanism units 281 can be arranged in an array or other pattern of any size.

The disclosed system 100 can be configured to generate a haptic meta-surface in accordance with the sensor data 130 as described above. Additionally, in other embodiments, the disclosed system 100 can be configured to activate and deactivate microswitches, open and close microfluidic channels, etc. The sensor data 130 may be LiDAR data as described above. Additionally, in other embodiments, the sensor data 130 may be two-dimensional still or video images or any other data captured by a sensor unit 120 in the environment 101 of the disclosed system 100. For example, when a camera moves from one color to another color (defined, for example, by grayscale values or average grayscale values relative to one or more predefined thresholds), a microswitch can be triggered without human error. Together, the disclosed system 100 enhances the design space for engineering components (e.g., medical systems, computer hardware, optical systems, electronic switches or microswitches, human-computer interaction components, etc.) where there is a need to operate a system in response to sensor data 130 at any size or frequency.

While preferred embodiments have been described above, those skilled in the art who have reviewed the present disclosure will readily appreciate that other embodiments can be realized within the scope of the invention. Accordingly, the present invention should be construed as limited only by the appended claims.

What is claimed is:

1. A device for generating a force in accordance with sensor data captured in an environment of the device, the device comprising:
a sensor unit that captures sensor data;
a compliant mechanism comprising:
one or more compliant mechanism units; and
one or more electromagnetic actuators, each electromagnetic actuator configured to actuate one of the one or more compliant mechanism units; and
a processing unit which:
extracts a pixel value from the sensor data for each of the one or more compliant mechanism units; and
outputs one or more control signals to actuate each of the one or more compliant mechanism units in accordance with the pixel value extracted for the compliant mechanism unit.

2. The device of claim 1, wherein:
the sensor unit comprises a light detection and ranging (LiDAR) scanner that outputs LiDAR data and extracting a pixel value for each of the one or more compliant mechanism units comprises:
generating a LiDAR pixel map based on the LiDAR data; and
extracting a pixel value from the LiDAR pixel map for each of the one or more compliant mechanism units.

3. The device of claim 2, wherein the one or more pixel values extracted from the LiDAR pixel map are indicative of a height of an object at a location in the environment or a distance of an object from the device.

4. The device of claim 1, wherein:
the compliant mechanism comprises a plurality of compliant mechanism units; and
the processing unit extracts a pixel value for each compliant mechanism unit by reducing the sensor data into an array of pixel values, each pixel value corresponding to one of the compliant mechanism units.

5. The device of claim 4, wherein the processing unit calculates the control signal for actuating each compliant mechanism unit in accordance with the pixel value corresponding to the compliant mechanism unit.

6. The device of claim 1, wherein the sensor data comprises two-dimensional image data and the pixel value extracted from the two-dimensional image data comprises a grayscale pixel value.

7. The device of claim 1, wherein the sensor unit comprises ultrasonic proximity detectors, a radar system, or a sonar sensor.

8. The device of claim 1, wherein:
the compliant mechanism forms a haptic meta-surface comprising a flexible membrane supported by the one or more compliant mechanism units; and
the processing unit controls a shape of the haptic meta-surface by actuating the one or more compliant mechanism units in accordance with the sensor data.

9. The device of claim 1, wherein each of the one or more compliant mechanism units is configured to actuate a microswitch.

10. The device of claim 1, wherein each of the one or more compliant mechanism units is configured to open or close a microfluidic channel.

11. A method for actuating one or more compliant mechanism units in accordance with sensor data, the method comprising:
capturing sensor data;
extracting a pixel value from the sensor data for each of the one or more compliant mechanism units;
generating one or more control signals in accordance with the sensor data; and
outputting control signals to one or more electromagnetic actuators, each electromagnetic actuator configured to actuate one of the one or more compliant mechanism units in accordance with the control signals.

12. The method of claim 11, wherein:
capturing sensor data comprises the sensor unit capturing light detection and ranging (LiDAR) data; and
extracting a pixel value for each of the one or more compliant mechanism units comprises:
generating a LiDAR pixel map based on the LiDAR data; and
extracting a pixel value from the LiDAR pixel map for each of the one or more compliant mechanism units.

13. The method of claim 12, wherein the one or more pixel values extracted from the LiDAR pixel map are indicative of a height of an object at a location in the environment or a distance of to an object in the environment.

14. The method of claim 1, wherein:
the compliant mechanism comprises a plurality of compliant mechanism units; and
extracting a pixel value for each compliant mechanism unit comprises reducing the sensor data into an array of pixel values, each pixel value corresponding to one of the compliant mechanism units.

15. The method of claim 14, further comprising:
calculating a control signal for actuating each compliant mechanism unit in accordance with the pixel value corresponding to the compliant mechanism unit.

16. The method of claim 15, wherein the sensor data comprises two-dimensional image data and the pixel value extracted from the two-dimensional image data comprises a grayscale pixel value.

17. The method of claim 11, wherein the sensor data comprises ultrasonic proximity data, a radar data, or a sonar data.

18. The method of claim 11, wherein:
the compliant mechanism forms a haptic meta-surface comprising a flexible membrane supported by the one or more compliant mechanism units; and
the one or more compliant mechanism units are actuated in accordance with the sensor data to control a shape of the haptic meta-surface.

19. The method of claim 11, wherein each of the one or more compliant mechanism units is configured to actuate a microswitch.

20. The method of claim 11, wherein each of the one or more compliant mechanism units is configured to open or close a microfluidic channel.
